(19) United States
(12) Patent Application Publication
(10) Pub. No.: US 2005/0219942 A1
(43) Pub. Date: Oct. 6, 2005

(54) Low profile mixing plant for particulate materials

(76) Inventor: Kris Wallgren, Penetag (CA)

Correspondence Address: STITES & HARBISON PLLC, 1199 NORTH FAIRFAX STREET, SUITE 900, ALEXANDRIA, VA, 22314, US

(21) Appl. No.: 11/055,702

(22) Filed: Feb. 11, 2005

Related U.S. Application Data
(60) Provisional application No. 60/543,273, filed on Feb. 11, 2004.

(51) Int. Cl. B28C 7/06

(52) U.S. Cl. 366/30

(57) ABSTRACT

A low profile particulate mixing plant is described. The plant is suitable for discharging the components of a particulate mixture. The plant includes a pair of storage receptacles located side-by-side. Each of the receptacles has a discharge adjacent an underside thereof to transfer a component of the particulate material mix within each receptacle to a respective conveyor at a height adjacent to ground level. The conveyor elevates the components from the discharges to a mixing station spaced from the receptacles. The plant is suitable for use as a concrete mixing plant.

This application claims the benefit of U.S. Provisional Application No. 60/543,273, filed Feb. 11, 2004.

### FIELD OF THE INVENTION

The present invention relates generally to mixing plants for particulate materials, and more specifically, the present invention is adaptable to concrete mixing plants.

### BACKGROUND OF THE INVENTION

It is conventional to deliver concrete to a construction site on a vehicle equipped with a mixing drum. The concrete is thus delivered as a fully mixed slurry and can be dispatched directly to the ultimate location in which it is to be used. The mixing vessels are charged with the materials from which the concrete is mixed at a batch plant. Typically the batch plant includes silos for the aggregate and the cement powder which are discharged in the required ratios from the undersides of the silos into the mixing vessel of the vehicle for mixing with water to make concrete slurry.

In prior art installations, the silos are mounted on a gantry of sufficient height or elevation so that the vehicle may be moved below the silos and the components formulating the concrete can be discharged into the mixing vessel. In such an arrangement, the aggregate and cement powder are “gravity fed” to the mixing vessel. While such a stacked arrangement that has the silos mounted over the gantry facilitates the discharge of materials, it also introduces significant structural complexities. Each silo not only contain a significant mass of the components but also present a relatively large surface area to cross-winds. Since each silo is freestanding, the foundation of the plant has to be capable of withstanding not only the vertical loading resulting from each of the laden silos but also the wind loading externally imposed on each silo. The elevation of each silo on the gantry produces significant bending loads upon the gantry which places further structural requirements upon the gantry and its foundations. Further, the elevation of a silo tends to expose the silo to greater earthquake loads.

In other known installations, the mixing vessel can be “conveyor fed” instead of gravity fed. In one type of such installations, only the cement powder silo is stacked over the mixing station or gantry, while the aggregate silo is placed apart from the gantry on the foundation of the plant. The aggregate is discharged from the underside of the aggregate silo, and then “conveyor fed” to the gantry. There are different conveyors that are suitable for conveying aggregate to the gantry, as is known in the art, and typically a belt conveyor is selected for its ability to cover a greater transport distance. In such an installation, it is possible to lower the aggregate silo and then have the conveyor transport the aggregate discharged from the underside of the silo to the height of the gantry.

In another type of such installations, neither the cement powder nor aggregate silos are stacked over the gantry, and both silos are spaced apart on the foundation of the plant. In this latter type of installations, the cement powder may also be conveyor fed to the gantry. However, conventional belt conveyors are typically not suitable for transporting very fine materials such as cementitious powder, since such conveyors cannot effectively impart the motion of the belt to the powder material being transported, and hence the transport of the material along the belt cannot be effectively controlled. Due to the very fine nature of cement powder, unenclosed belt transport is also typically not used because even very gentle winds may remove some cement powder from the belt, and hence even with a controlled discharge from the silo onto the input end of the belt, it is difficult to predict the amount of cement powder that will be discharged from the output end of the belt conveyor. As such, this type of installation typically use a screw-type conveyor to transport the cement powder from the underside of the silo to the gantry. A screw-type conveyor typically propagates material along an enclosed tube by turning a “screw” core enclosed within the conveyor. However, due to the very high power required to operate a screw-type conveyor, the length of such a conveyor is typically limited to approximately thirty feet, and the incline to which the conveyor may operate in this type of installation is typically limited to approximately forty-five degrees. As such, even though the cement powder silo is not stacked over the gantry in such a prior art installation, the silo is still placed at approximately the same height as if the gantry was underneath the silo, since the length and angle of the cement powder conveyor places severe restrictions on the height position of the cement silo in order for the output end of the cement conveyor to reach the height of the gantry. As such, the elevation of the cement powder silo in this type of installation remains subject to significant bending loads that imposes significant structural requirements upon the support structure of the silo and its foundations.

It is therefore an object of the present invention to provide a batch plant for particulate materials, such as those intended for concrete formulations, in which the above disadvantages are sought to be obviated or mitigated.

### SUMMARY OF THE INVENTION

In a broad aspect of the present invention, there is provided a batch plant suitable for discharging the components of a particulate mixture. The plant includes a pair of storage receptacles located side-by-side. Each of the receptacles has a discharge on an underside thereof to transfer the constituent components within each receptacle to a respective conveyor at a height adjacent to ground level. The conveyor elevates the components from the discharges to a mixing station spaced from the receptacles. The mixing station may include a delivery collection chute to receive the components from each of the conveyors, and the collection chute may be located at an elevated position to permit a vehicle and one or more mixing vessels to be positioned beneath the collection chute.

In one aspect of the present invention, a mixing plant for particulate material is provided. The mixing plant comprises a first storage receptacle having a discharge port adjacent an underside thereof for discharging a first component of a particulate material mix at a discharge height adjacent to ground level of the plant; and a belt conveyor positioned to receive the first component from the discharge port and convey the first component to a mixing station for mixing with a second component of the particulate material mix. The mixing station receives the first component from the belt conveyor at a height above the discharge height for delivery to a mixing vessel associated with the mixing station for mixing the first component with the second component.

The belt conveyor may be a rubber belt, and the rubber belt may have sidewalls and protrusions thereon. The belt conveyor may further include an outer shell that substantially encloses the rubber belt within the belt conveyor except for an input opening for receiving the first component from the discharge port and an outlet for discharging the first component at the mixing station.

The first component may be cement powder, the second component may be aggregate, the mixing vessel may be provided with water from the missing station, and the particulate material mix may be concrete slurry.

The first storage receptacle may include a discharge control apparatus for controlling discharge of the first component to the belt conveyor. The discharge height may be approximately no more than 8 feet or 4 feet from ground level.

The mixing plant may further comprise a second storage receptacle disposed side-by-side to the first storage receptacle along a foundation of the plant and structurally connected thereto to form an integral unit. The second component may be discharged from the second storage receptacle to a second conveyor at substantially the discharge height to be conveyed to the mixing station for delivery to the mixing vessel.

The mixing vessel may be located on a transport truck at the mixing station. The mixing vessel may also be structurally connected to the mixing station.

In another aspect of the present invention, a mixing plant for particulate material is provided. The mixing plant comprises a first storage receptacle for dispensing a first component of a particulate material mix; and a second storage receptacle for dispensing a second component of the particulate material mix for mixing with the first component to make the particulate material mix. The second storage receptacle is disposed side-by-side with the first storage receptacle along a foundation of the plant, and the second storage receptacle is structurally connected to the first storage receptacle to form an integral unit.

The first and second storage receptacles may be structurally connected by a plurality of fasteners passing through flanges of adjacent walls of the first and second storage receptacles. Each of the first and second storage receptacles may discharge their respective component of the particulate material mix through a respective first and second discharge port provided adjacent the underside of each respective storage receptacle.

The mixing plant may further comprise a mixing station for receiving the first and second components and delivering the first and second components to a mixing vessel associated with the mixing station; a first conveyor positioned to receive the first component from the first storage receptacle for transporting the first ingredient to the mixing station for delivery to the mixing vessel; and a second conveyor positioned to receive the second component from the second storage receptacle for transporting the second component to mixing station for delivery to the mixing vessel mixing for mixing with the first component. The mixing station may be laterally spaced from the integrated unit, and the mixing station may receives the first and second components from the first and second conveyors at a height above the first and second discharge ports.

The first and second conveyors may be belt conveyors, the first component may be cement powder and the second component may be aggregate. The first conveyor may comprise a rubber belt substantially enclosed within an outer shell except for an input opening for receiving the first component from the first storage receptacle and an outlet for discharging the first component at the mixing station, the rubber belt having sidewalls and protrusions thereon.

The first storage receptacle may include a first discharge control apparatus associated with the first discharge port for controlling discharge of the first component onto the first conveyor; and the second storage receptacle may include a second discharge control apparatus associated with the second discharge port for controlling discharge of the second component onto the second conveyor.

The first and second discharge control apparatuses may each be associated with at least one load cell for measuring a quantity of the respective first and second component before their discharge onto the respective first and second conveyors.

The first storage receptacle may comprise a first platform positioned near the first discharge control apparatus for supporting a plant operator, the second storage receptacle may comprise a second platform positioned near the second hopper for supporting the plant operator, and the first and second platforms may be substantially co-planar and connected along one adjacent edge.

The first and second storage receptacles may be positioned over the respective first and second conveyors at a discharge height adjacent to the ground level of the plant. The discharge height may be approximately no more than 8 feet from ground level.

### BRIEF DESCRIPTION OF THE DRAWINGS

By way of illustration and not of limitation, embodiments of the present invention are next described with reference to the following drawings, in which:

FIG. 1 is an end elevation view of a plant according to an embodiment of the present invention;

FIG. 2 is a side elevation view of the plant shown in FIG. 1;

FIG. 3 is an end elevation view of the plant in a direction opposite to that of FIG. 1;

FIG. 4 is a side elevation view of a mixing station of the plant in a direction opposite to that of FIG. 2;

FIG. 5 is a plan view of the plant shown in FIG. 1.

FIG. 6 is a cross-section of a conveyor of the plant shown in FIG. 1 taken at line A′-A′ of FIG. 5;

FIG. 7a is an cross-section of the conveyor of the plant shown in FIG. 1 taken at line B′-B′ of FIG. 6;

FIG. 7b is a perspective view of a section of a belt of the conveyor shown in FIG. 6;

FIG. 8 is an end view of a discharge control apparatus of the plant shown in FIG. 1;

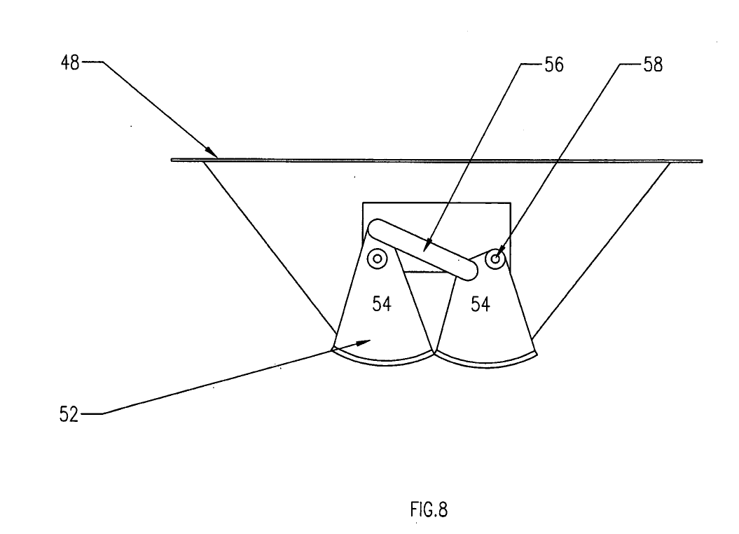

FIG. 9 is a perspective view of the discharge control apparatus shown in FIG. 8 in an alternative configuration;

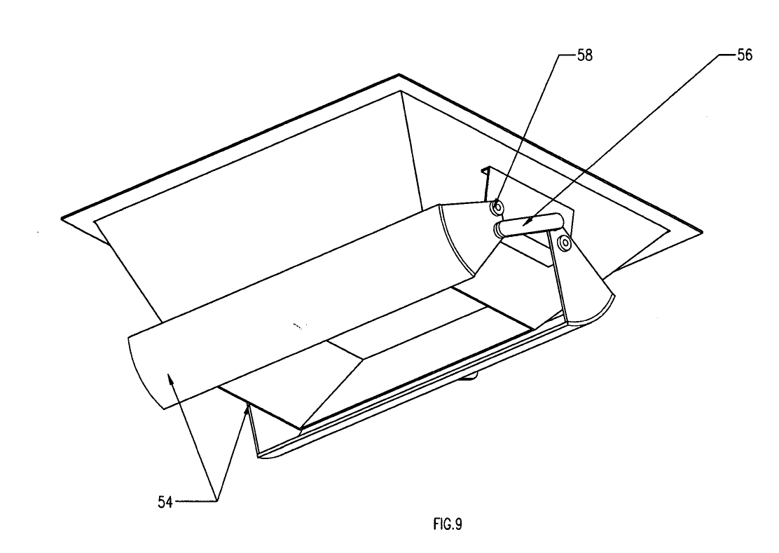

FIG. 10 is a perspective view of an alternative plant according to another embodiment of the present invention; and

FIG. 11 is an end elevation view of a mixing station in yet another embodiment of the present invention.

### DETAILED DESCRIPTION OF EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

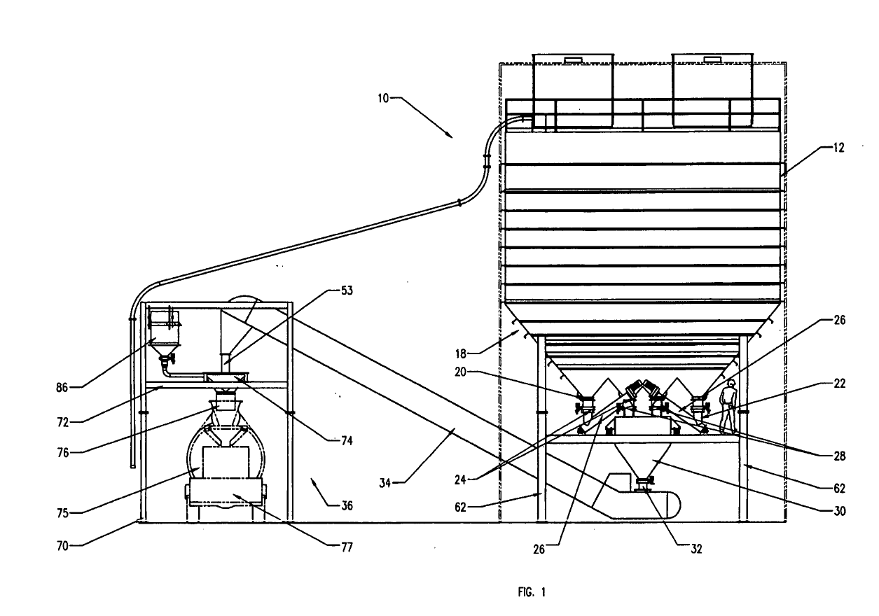

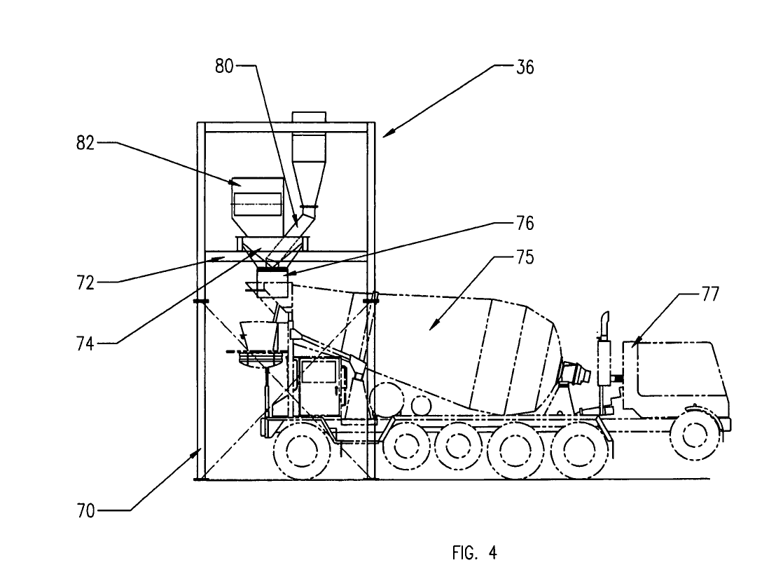

Referring to FIGS. 1 through 4, in one embodiment a plant generally indicated 10 has a pair of storage receptacles such as silos 12, 14 and a mixing station such as gantry 36 spaced apart from the silos 12, 14. The silos 12, 14 may be mounted upon a support structure, such as legs 62, to a foundation (not shown) in the ground of plant 10. The silos 12, 14 may be placed in a side by side along a foundation (not shown) of a plant and structurally connected to one another to form an integral unit. This may be done for example by fasteners such as bolts passing through flanges of adjacent walls of each silo, or through the adjacent walls of each silo. It will be appreciated that other structural connections may be used in other embodiments. Where the silo 12 is designed to contain cement, a typical installation for same may hold approximately 300 tonnes of cementitious powder. On the other hand, the silo 14 may be designed to contain aggregate. It will be appreciated that silos 12 and 14 may be modular in design, such that the capacities of each silo may be adjusted with the addition or removal of sections in the silo, as is known in the art. The modular design of silos 12 and 14 tends to permit greater portability of plant 10, such that the ease with which plant 10 may disassembled, moved to another location and reassembled is promoted.

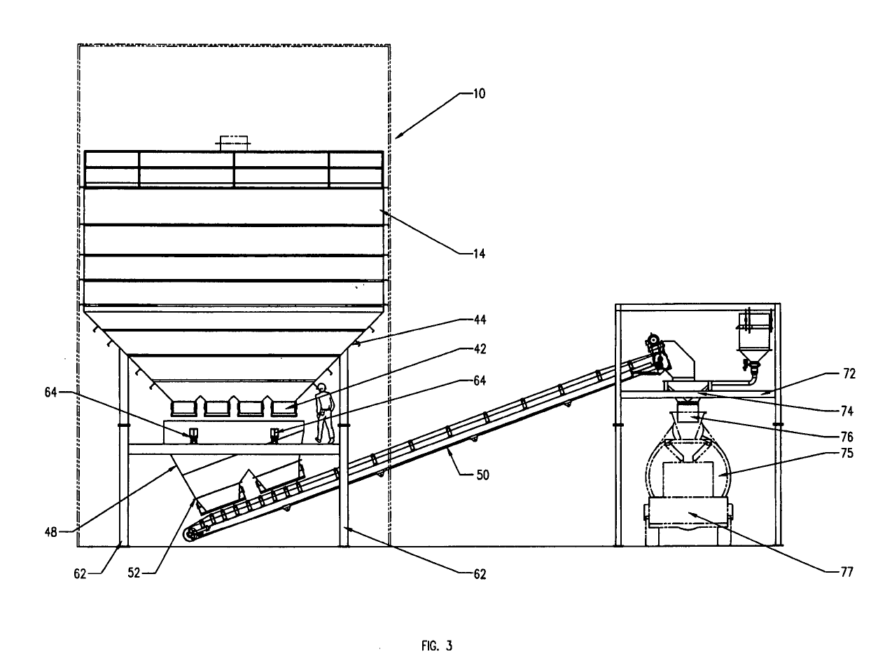

In the embodiment, silos 12 and 14 discharge their respective stored contents from their respective undersides. Silos 12, 14 may each have a discharge control apparatus for controlling discharge from the respective silo 12 or 14. For instance, the discharge control apparatus for silo 12 includes lower portion 18 of the silo 12, discharge ports 20, 22, 24, hopper 30, and load cells 64 associated with hopper 30. The lower portion 18 may be downwardly and inwardly tapered to converge to discharge ports 20, 22, 24. Discharge ports 24 are arranged directly over a hopper 30, while discharge ports 20, 22 are not arranged over hopper 30 and are instead connected to augers 26 that transfer the cementitious powder upwardly to a set of aligned discharge ducts 28. The ducts 28 discharge powder into hopper 30 which collects the discharged cement powder and deposits the cement powder on to a conveyor 34 through an outlet 32 of hopper 30. Hopper 30 is associated with load cells 64 that permit the cement powder to be measured prior to discharge onto conveyor 34. Likewise, the silo 14 may be provided with a discharge control apparatus having a pair of outlet doors 42 arranged side-by-side to one another at its lower portion 44. The outlet doors 42 extend longitudinally as can best be seen in FIG. 3 and may be actuated between open and closed positions by hydraulic or pneumatic cylinders 46, or by any other activation means known to those of skill in this art. The doors 42 may be positioned over an aggregate hopper 48 that in turn may be positioned over an aggregate conveyor 50. Hopper 48 may also be associated with load cells 65 that permit the aggregate to be measured before it is discharged onto conveyor 50. While a discharge control apparatus with components external to the silos, such as hopper 30 and 48, is described above, it will be appreciated that a discharge control apparatus for a silo with another configuration of components may be housed internally within the silo in other embodiments.

Each of the hoppers 30, 48 may be supported on platforms 60, 61 or the like, respectively, each of which extends between legs 62 that support the silos 12, 14. It will be appreciated that platforms 60, 61 may be supported and connected to legs 62 by structural attachments, as is known in the art.

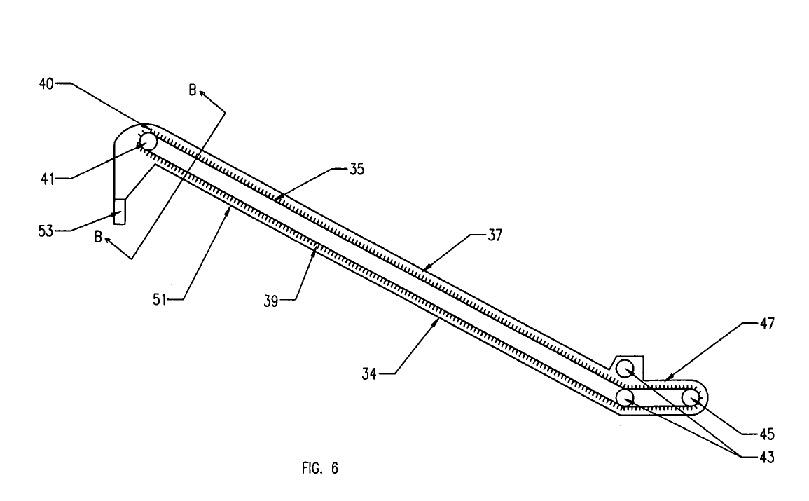

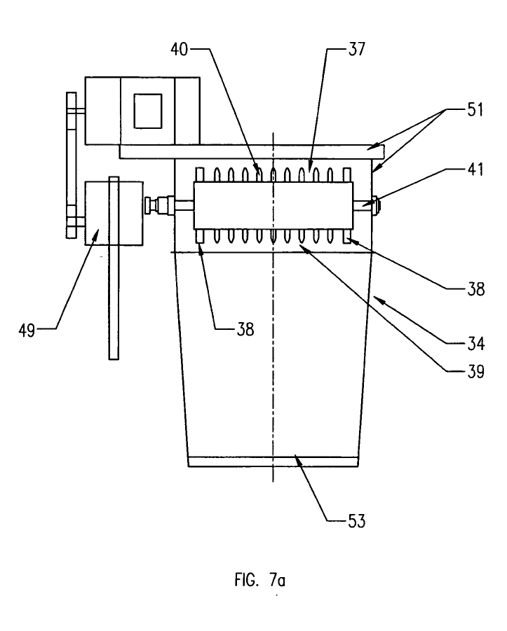

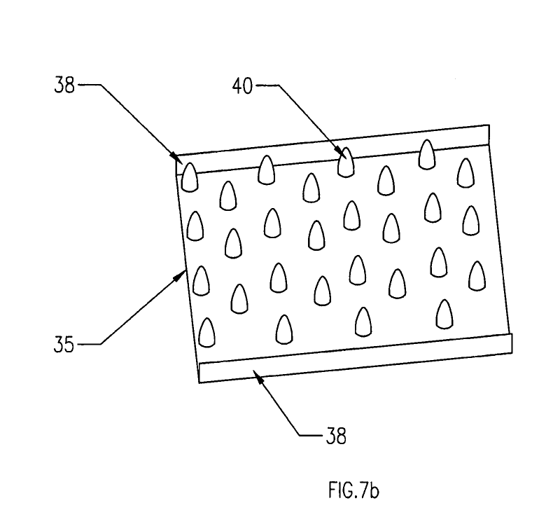

The conveyor 34 is configured to transfer cement powder to a mixing station, such as gantry 36, that is located laterally to one side of the silos 12, 14. In an illustrated embodiment, the conveyor 34 is a belt conveyor having belt 35 enclosed within an outer shell 51 that is just larger than the cross section of belt 35. Except for input opening 47 and dispensing outlet 53, outer shell 51 substantially encloses belt 35 within belt conveyor 34. Referring to FIGS. 6, 7a, and 7b, belt 35 has pleated sidewalls 38 and a series of upstanding protrusions, such as spikes or nubs 40 disposed between the sidewalls 38 on belt 35. For the illustrated embodiment, the sidewalls 38 are nearly flush with the interior surface of outer shell 51 to create notional volumes 37 and 39 within belt conveyor 34. In the illustrated embodiment, spikes 40 are arranged in rows running parallel to the transverse axis of belt 35. As shown in FIG. 7b, there are gaps between spikes 40 in each row, and the spikes 40 of an adjacent row are disposed to appear in line with the gaps of the adjacent rows along the longitudinal direction of the belt 35. It will be appreciated that other protrusions or patterns of protrusions, such a ridges extending from sidewall to sidewall, may be used in other embodiments. While prior art belt conveyors have been known to be unsuitable for transporting cementitious materials, it has been surprisingly found that a belt having sidewalls and protrusions thereon is effective for moving relatively particulate materials, such as cement powder.

Belt 35 may be configured with two or more pulley rollers, shown in FIG. 6 as rollers 41, 43 and 45, to permit belt 35 to be adjusted to match the shape of belt conveyor 34. It will be appreciated that other shapes may be provided with different configurations of pulley rollers in other embodiments. For instance, a “Z” shaped belt conveyor, as opposed to the “L” shaped conveyor 34 shown in FIG. 6, may be achieved with placing additional turn pulley rollers near roller 41, as would be apparent to one skilled in this art. In an embodiment, an incline angle of up to seventy-five degrees may be attempted with conveyor 34.

Referring to FIG. 7, head pulley 41 may be driven by a drive means, such as motor 49. It will be appreciated that in other embodiments, one or more drive means may be used to drive one or more of the head, turn and tail pulleys in the belt conveyor. When motor 49 is engaged to turn pulley roller 41 in a counter-clockwise direction with reference to FIG. 6, belt 35 is propelled to transport cement powder deposited thereon through volume 37. The spikes 40 impart the motion of belt 35 to the cement powder deposited onto belt 35 through input opening 47 of belt conveyor 34, and transport the powder to dispensing outlet 53 of the belt conveyor 34 to dispense the cement powder at gantry 36.

For the embodiment, belt 35 may be moulded from rubber or flexible plastics material, and sidewalls 38 and spikes 40 may be moulded integrally with belt 35. Additionally, sidewalls 38 and spikes 40 may project the same height from belt 35. It will be appreciated that other materials may be used for the belt, sidewalls, and spikes in other embodiments. For an embodiment, the belt may be approximately thirty-six inches in width, with spikes of 3¼″ height and a widest width of ¾″. It will be appreciated that the choice of belt width, spike height and width may vary in different applications depending on the desired flow rate in the conveyor for the particular application.

Using a belt conveyer 34 as described in the embodiment, a conveyor length of at least thirty-five feet may be attempted. In other embodiments, conveyor lengths of approximately fifty feet, and longer, may be attempted. It will also be appreciated that different heights of different mixing stations may be reached by conveyors 34 and 50 by adjusting the length of the conveyors, the angle of the conveyors, or both the length and angle of the conveyors.

Suitable belt conveyors as described above are available from a number of sources, such as under the trade-marks CamFleX™ and CamBelt™. Surprisingly, it has been found that such conveyors as described can effectively transfer cementitious powder in a controlled, predictable manner. For the illustrated embodiment, control over the transfer of cement powder is provided by the sidewalls 38 and spikes 40 of belt 35, which imparts the motion of the belt 35 onto the cement powder being transferred. Predictability in the amount of cement powder discharged from dispensing outlet 53 is provided by the enclosed nature of conveyor 34, which tends to ensure that cement powder discharged from hopper 30 is conveyed to outlet 53.

Additionally, it will be appreciated that due to the enclosed nature of belt conveyor 34, cement powder may be transported from silo 12 to gantry 36 with reduced contamination of the environment and air quality of plant 10 despite the relatively fine and dusty nature of cement powder. In one embodiment, outlet 32 for connecting the discharge of hopper 30 to input opening 47 of conveyor 34 is substantially sealed to further minimize powder “kick-up” as the cement powder is deposited onto belt 35. Such an outlet 32 tends to further reduce powder kick-up to hoppers 30, 48 and load cells 64, 65, and thus tends to reduce the amount of cleaning and maintenance required to maintain hoppers 30, 48 and load cells 64 in good working condition.

For the illustrated embodiment, discharge from the hopper 48 may be controlled by a pair of gates 52 disposed substantially along the longitudinal axis of the conveyor 50. In the embodiment, conveyor 50 is also a belt conveyor suitable for moving material such as aggregate, as is well-known in the art. Other conveyors will be apparent to one skilled in this art. The gates 52 are shown in greater detail in FIGS. 6 and 7, and include a pair of pivoted clamshell doors 54 interconnected by an operating link 56. The doors 54 are pivotally connected through bolts 58 or other suitable fasteners to the sidewalls of the hopper 48. The doors 54 are actuated by an appropriate drive means, such as a fluid motor (not shown), so as to swing from a fully opened to a fully closed position over conveyor 50 to discharge the stored contents of silo 14, such as aggregate, onto conveyor 50. As already described, conveyor 50 may be positioned to extend from beneath the doors 54 to carry the discharged contents of silo 14 upwardly to the gantry 36.

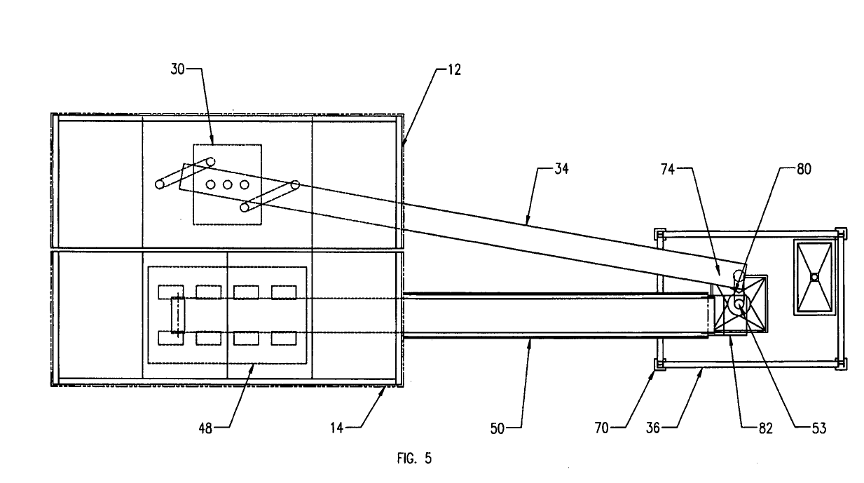

The mixing station or gantry 36 includes a support structure, such as legs 70 supporting a platform 72, to house the appropriate components for collecting the constituent components of a desired batch mix, such as concrete slurry, above a mixing vessel. In one embodiment, gantry 36 is arranged to provide platform 72 above a mixing vessel 75 located on a vehicle 77. Typical heights of a vehicle 77 with a vessel thereon are in the range of 11′6″ to 13′6″. In an illustrated embodiment, gantry 36 is provided with a collection chute 74 that is centrally located on the platform 72 with a discharge shroud 76 extending downwardly to be positioned at the inlet of a mixing vessel 75 located on a truck 77. The collection chute 74 may be frustoconical and each of the conveyors 34, 50 converges toward to the inlet of the collection chute 74 to deliver the material carried by each conveyor 34, 50 thereinto. As can best be seen in FIG. 5, for the illustrated embodiment the outlet 53 of conveyor 34 allows cement powder to discharge through a conduit such as tubular duct 80 so as to be centrally placed within the collection chute 74. The aggregate conveyor 50 may discharge aggregate as a steady stream through a conduit such as hood 82 that guides the aggregate to delivery through the collection chute 74.

In use, the vehicle 77 may be positioned below the collection chute 74 ready to receive a batch of constituent components from which the concrete can be mixed. At silo 14, the doors 42 are actuated to supply aggregate to the hopper 48 with the load cells 65 indicating when the requisite mass of aggregate has been deposited. The doors 58 of hopper 48 are then opened and the aggregate discharged onto the conveyor 50 for delivery through collection chute 74 and into the vessel 75. At silo 12, the cement powder is discharged into the hopper 30 and the load cells 64 measures the requisite mass, and then the cement powder is deposited on the conveyor 34 through outlet 32. The cement powder is then conveyed by conveyor 34 to the gantry 36 and discharged through the shroud 74. The timing of the supply of the aggregate together with cementitious powder is selected such that the aggregate is dispensed before, during and after the supply of the cementitious powder. Other timing of the supply of aggregate, cement powder and water will be apparent to one of skill in this art. Water may be supplied to the vessel 75, for instance from a reservoir 86 located on the gantry 36. Once the requisite components have been deposited in the mixer, the vehicle 77 can be removed and the plant 10 readied for delivery of a subsequent batch constituent component of concrete to the next truck.

As already described above, silos 12, 14 are placed side by side to each other and structurally connected to one another to form an integral unit. A connection by bolts passing through adjacent walls of silos 12 and 14 may be preferred by some in this art because this may provide greater ease for disassembling and reassembling plant 10, for instance as a result of transport to another location. It will be appreciated that the placement of the silos side-by-side and the provision of the gantry 36 at a laterally spaced location enables a lower overall profile to be used for the silos 12, 14 and gantry 36, since silos 12, 14 are no longer stacked on top of gantry 36 as prevailing in the prior art. Furthermore, it will be appreciated that the use of a belt conveyor to convey cementitious powder to the gantry 36 allows for a greater height differential between the discharge at silo 12 and the collection chute 74 located at gantry 36, such that silo 12 may discharge its stored contents at a discharge height that is adjacent to ground level of the plant 10. As such, both silos 12 and 14 may be lowered to discharge their respective stored contents at a discharge height that is adjacent to ground level. The discharge height is the vertical distance from ground level at which the contents of a silo is discharged from the silo. In an embodiment where the contents of silos 12, 14 are first discharged onto an external discharge control apparatus, such as hoppers 30 and 48, the discharge height may be approximately 12 to 15 feet. In another embodiment where the discharge control apparatus is internal to a silo, the discharge height may be approximately 5 feet. The discharge height is adjacent to, but not exactly at, ground level because space is reserved for placement of a conveyor beneath the discharge height for transporting the discharged contents from the silos to a mixing station.

It will be appreciated that the lower profile of silos 12, 14 imposes less structural requirements upon the foundation than prior art plants having silos of higher profile, and less structural requirements for the bracing structure for legs 62 of silos 12, 14. For example, the lower profile of silos 12, 14 tends to reduce the wind load and earthquake load that may be experienced by silos 12, 14. Thus, with less wind and earthquake load, less reaction is generated on the foundation and as such, the requirements of depth and strength for the foundation will tend to also be reduced. This in turn allows the foundation of plant 10 to be prepared at reduced cost, and also permits greater ease to move plant 10 to another location, if desired. The lower profile of silos 12, 14 further provides the advantage of being easier to load with cement powder and aggregate in embodiments in which silos 12, 14 are top-loaded and dispensing is gravity-fed. In such embodiments, the lowering of silos 12 and 14 also presents a shorter height to transport the cement powder or aggregate into silos 12 or 14, respectively by way of, for example, pneumatic pumps.

In an illustrated embodiment, the arrangement of gantry 36 laterally spaced from silos 12 and 14 may permit the lowering of the discharge height of silos 12 and 14 by approximately ten to fifteen feet, or more, as compared to known batch plants having space reserved for a gantry underneath the silos. As such, the silos 12, 14 may be lowered to dispense the cement powder and aggregate from silos 12 and 14, respectively, at a discharge height adjacent to ground level onto conveyors 34 and 50, and then conveyors 34, 50 enable the cement powder and aggregate to be elevated from approximately the discharge height to the height required for discharge into, for example, the collection chute 74 at gantry 36. For instance, the silos 12, 14 may dispense concrete powder and aggregate, respectively, at approximately eight feet from ground level into hoppers 30 and 48, respectively; and hoppers 30 and 48 may dispense concrete powder and aggregate onto conveyors 34 and 50, respectively, at approximately four feet from ground level.

The interconnection of silos 12, 14 adds to the bending stiffness and enhances stability of silos 12 and 14. By connecting silos 12, 14 to form an integrated unit, the footprint, or base area, of the integrated unit is greater than the footprint of either silo 12 or 14 alone. It will be appreciated that the increased footprint of the integrated unit reduces the bracing stress upon the structure of the individual silos 12 and 14, and hence also tends to reduce the structural requirements of the foundation of plant 10. It will also be appreciated that the integrated unit tends to provide greater wind resistance to lateral acceleration of silos 12 and 14 from cross-wind, since in one direction the integrated unit provides a longer “lever” along the increased base area through which force may be distributed to resist motion from cross-wind. Further, greater resistance also tends to be provided to earthquake loads. This latter aspects also tends to reduce the structural requirements of the foundation of plant 10, which as already described enhances the portability of plant 10.

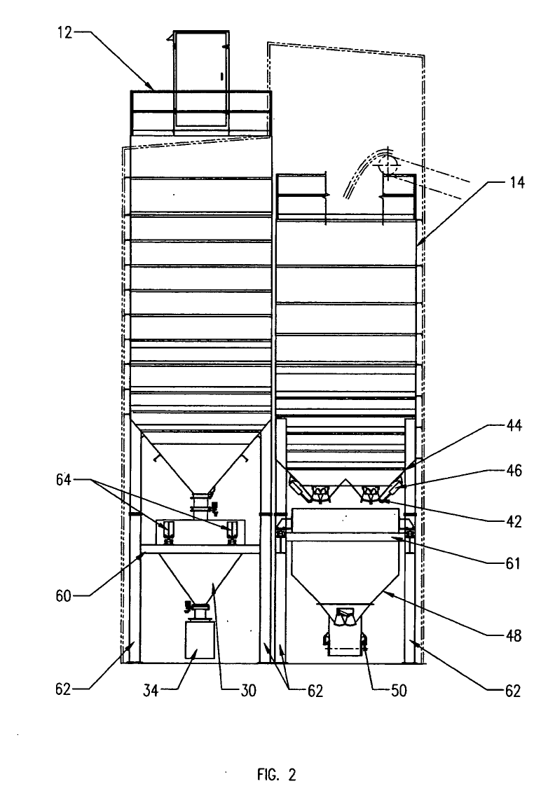

For an illustrated embodiment, silos 12 and 14 are each provided with a platform 60 and 61, respectively, for supporting plant operators as they perform their tasks near the hoppers 30, 48 in plant 10. As shown in FIG. 2, platform 61 may be raises slightly above platform 60.

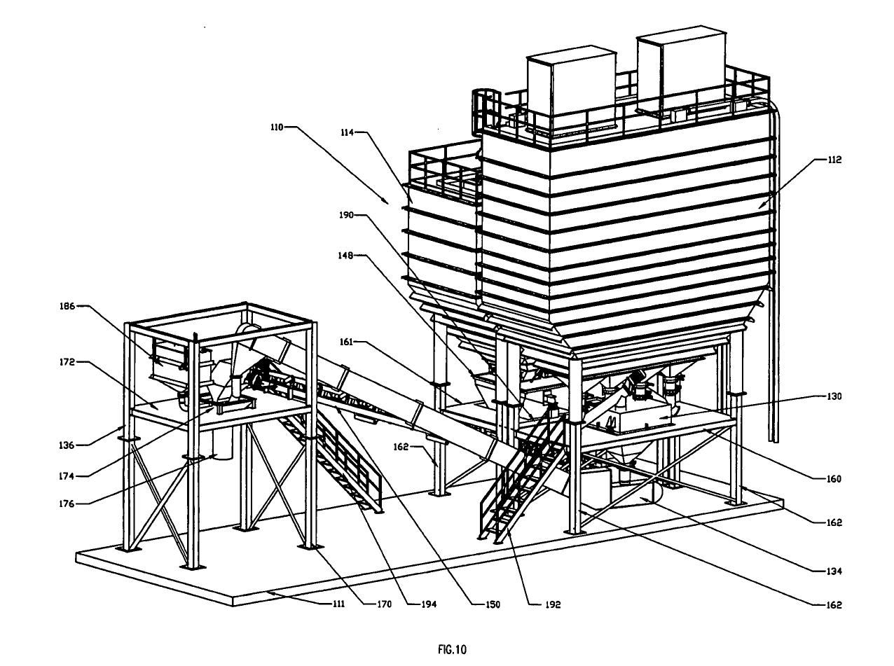

Referring to FIG. 10, another embodiment is shown in which a plant 110 has silos 112, 114 located side-by-side along a foundation 111. The plant 110 is similar to plant 10 described above. Hoppers 130 and 148 are positioned underneath silos 112 and 114 respectively to receive their stored contents through discharge ports on the underside of silos 112 and 114. Hopper 130 is positioned above a conveyor 134 to discharge the contents of silo 112 onto the conveyor 134, and hopper 148 is positioned above a conveyor 150 to discharge the contents of silo 114 onto the conveyor 150. Conveyors 134 and 150 may be similar to conveyors 34 and 50 described above for transporting the contents of silos 112, 114 to a mixing station or gantry 136. Gantry 136 as shown includes a platform 172 supported on legs 170. Gantry 136 may be provided with a collection chute 174 to receive the contents of silos 112 and 114 from conveyors 134 and 150, respectively, and delivering such contents thorough a discharge shroud 176 to a mixing vessel (not shown). Water may be supplied to a mixing vessel from a reservoir 186 located with the gantry 136. The plant 110 differs from plant 10 described above in that platforms 160 and 161 provided near hoppers 130 and 148 are substantially co-planar, and are connected along an edge 190 along adjacent sides of platforms 160 and 161. The connected platforms 160, 161 provides plant workers with extra space on which to perform their tasks along the side of each platform between the hoppers 130 and 148. Since the distance between the hopper and the edge of the platform may be as little as approximately two feet in some plant installations, the doubling of that distance to four feet along one adjacent edge that results from the connection of platforms 160, 161 in the illustrated embodiment may tend to be significant to plant operators in some plant installations. For instance, it may be advantageous in some installations to provide extra space for plant workers to perform maintenance tasks on hoppers 130 and 148. It will be appreciated that in other embodiments, the platforms of each silo may not be perfectly co-planar but are disposed at slightly different heights and angles, but still tending to provide the advantage of increased space for plant operators where the platforms are substantially connected along one edge and operators can make concurrent use the surface space of both platforms along the connected adjacent edge. In yet another embodiment, there may be a single platform spanning the area of platforms 160 and 161. As shown in FIG. 10, staircases 192 and 194 are provided for plant workers to reach (i) platforms 160, 161 and (ii) gantry 136, respectively, from ground level which as illustrated is shown as the ground surface of foundation 111.

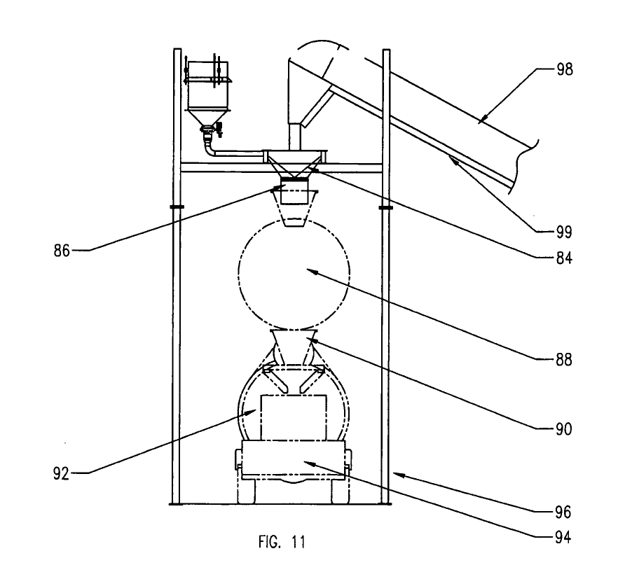

Referring to FIG. 11, an alternative embodiment of a mixing station or gantry 86 is shown. Gantry 86 is similar to gantry 36 described above, except that its collection chute 84 and discharge shroud 86 leads to a central mixer 88 structurally connected to gantry 86, rather than a mixing vessel located on a truck. Central mixer 88 pre-mixes the concrete slurry, which is then discharged through outlet 90 into vessel 92 of truck 94 for transport from a concrete plant. In some applications, it is preferred to have a central mixer located within a concrete plant to mix the constituent ingredients of concrete before discharge into a truck for transport, for instance in situations where a particular mixer is not available for installation upon a truck. Gantry 86 is thus taller than gantry 36, which does not have a central mixer disposed over the space reserved for a truck having a concrete vessel. While this tends to increase the structural requirements of foundation for gantry 86, such requirements are still typically much less than the requirements for support of the prior art cement and aggregate silos in most known plants.

Conveyors 98, 99 transporting cement powder and aggregate to gantry 86 are substantially the same as conveyors 34 and 50 already described, but arranged to discharge their material at gantry 86 at a greater height than at gantry 36. As described above, conveyors 98, 99 may be arranged to reach the required height by adjusting the length or angle, or both, of the conveyors previously described.

Although the present invention has been described with reference to certain specific embodiments, various modifications thereof will be apparent to those skilled in the art without departing from its spirit and scope.

1. A mixing plant for particulate material, comprising:
a first storage receptacle having a discharge port adjacent an underside thereof for discharging a first component of a particulate material mix at a discharge height adjacent to ground level of the plant; and
a belt conveyor positioned to receive the first component from the discharge port and convey the first component to a mixing station for mixing with a second component of the particulate material mix,
wherein the mixing station receives the first component from the belt conveyor at a height above the discharge height for delivery to a mixing vessel associated with the mixing station for mixing the first component with the second component.

2. The mixing plant of claim 1, wherein the belt conveyor comprises a rubber belt.

3. The mixing plant of claim 2, wherein:
the rubber belt has sidewalls and protrusions thereon; and
the belt conveyor further comprises an outer shell that substantially encloses the rubber belt within the belt conveyor except for an input opening for receiving the first component from the discharge port and an outlet for discharging the first component at the mixing station.

4. The mixing plant of claim 3, wherein:
the first component is cement powder;
the second component is aggregate;
the mixing vessel is provided with water from the missing station; and
the particulate material mix is concrete slurry.

5. The mixing plant of claim 4, wherein the first storage receptacle includes a discharge control apparatus for controlling discharge of the first component to the belt conveyor.

6. The mixing plant of claim 5, wherein the discharge height is no more than approximately 8 feet from ground level.

7. The mixing plant of claim 6, wherein the discharge height is no more than approximately 4 feet from ground level.

8. The mixing plant of claim 7, further comprising:
a second storage receptacle disposed side-by-side to the first storage receptacle along a foundation of the plant and structurally connected thereto to form an integral unit, wherein the second component is discharged from the second storage receptacle to a second conveyor at substantially the discharge height to be conveyed to the mixing station for delivery to the mixing vessel.

9. The mixing plant of claim 8, wherein the mixing vessel is located on a transport truck at the mixing station.

10. The concrete mixing plant of claim 8, wherein the mixing vessel is structurally connected to the mixing station.

11. A mixing plant for particulate material, comprising:
a first storage receptacle for dispensing a first component of a particulate material mix; and
a second storage receptacle for dispensing a second component of the particulate material mix for mixing with the first component to make the particulate material mix, the second storage receptacle being disposed side-by-side with the first storage receptacle along a foundation of the plant, and the second storage receptacle being structurally connected to the first storage receptacle to form an integral unit.

12. The mixing plant of claim 11, wherein the first and second storage receptacles are structurally connected by a plurality of fasteners passing through flanges of adjacent walls of the first and second storage receptacles.

13. The mixing plant of claim 12, wherein each of the first and second storage receptacles discharge their respective component of the particulate material mix through a respective first and second discharge port provided adjacent the underside of each respective storage receptacle.

14. The mixing plant of claim 13, further comprising:
a mixing station for receiving the first and second components and delivering the first and second components to a mixing vessel associated with the mixing station, the mixing station being laterally spaced from the integrated unit;
a first conveyor positioned to receive the first component from the first storage receptacle for transporting the first ingredient to the mixing station for delivery to the mixing vessel; and
a second conveyor positioned to receive the second component from the second storage receptacle for transporting the second component to the mixing station for delivery to the mixing vessel mixing for mixing with the first component,
wherein the mixing station receives the first and second components from the first and second conveyors at a height above the first and second discharge ports.

15. The mixing plant of claim 14, wherein:
the first and second conveyors are belt conveyors;
the first component is cement powder and the second component is aggregate; and
the first conveyor comprise a rubber belt substantially enclosed within an outer shell except for an input opening for receiving the first component from the first storage receptacle and an outlet for discharging the first component at the mixing station, the rubber belt having sidewalls and protrusions thereon.

16. The mixing plant of claim 15, wherein:
the first storage receptacle includes a first discharge control apparatus associated with the first discharge port for controlling discharge of the first component onto the first conveyor; and
the second storage receptacle includes a second discharge control apparatus associated with the second discharge port for controlling discharge of the second component onto the second conveyor.

17. The mixing plant of claim 16, wherein the first and second discharge control apparatuses are each associated with at least one load cell for measuring a quantity of the respective first and second component before their discharge onto the respective first and second conveyors.

18. The mixing plant of claim 17, wherein:
the first storage receptacle comprises a first platform positioned near the first discharge control apparatus for supporting a plant operator;
the second storage receptacle comprises a second platform positioned near the second hopper for supporting the plant operator; and
the first and second platforms are substantially co-planar and connected along one adjacent edge.

19. The mixing plant of claim 18, wherein the first and second storage receptacles are positioned over the respective first and second conveyors at a discharge height adjacent to the ground level of the plant.

20. The mixing plant of claim 19, wherein the discharge height is no more than approximately 8 feet from ground level.
